(19) United States
(12) Patent Application Publication
(10) Pub. No.: US 2024/0256834 A1
(43) Pub. Date: Aug. 1, 2024

(54) NEURAL NETWORK COMPUTING SYSTEM AND METHOD OF EXECUTING NEURAL NETWORK MODEL

(71) Applicant: SAMSUNG ELECTRONICS CO., LTD., Suwon-si (KR)

(72) Inventor: Jungho KIM, Suwon-si (KR)

(73) Assignee: SAMSUNG ELECTRONICS CO., LTD., Suwon-si (KR)

(21) Appl. No.: 18/543,628

(22) Filed: Dec. 18, 2023

(30) Foreign Application Priority Data
Jan. 26, 2023 (KR) 10-2023-0010076
Feb. 22, 2023 (KR) 10-2023-0023609

(51) Int. Cl. G06N 3/045

(52) U.S. Cl. CPC G06N 3/045

(57) ABSTRACT

Provided is a neural network computing system that includes: a processor comprising a plurality of computing devices, a memory storing at least one instruction related to execution of a neural network model, a memory controller; and a system bus. The processor is configured to execute the at least one instruction to: determine a normalized target performance of the neural network model, determine a normalized target performance of each of the plurality of computing devices, determine a normalized target performance of the memory controller and the system bus, determine an operating frequency for each of a plurality of hardware devices based on the determined normalized target performance(s), and execute the neural network model by operating the plurality of hardware devices based on the determined operating frequency for each of the plurality of hardware devices.

### CROSS-REFERENCE TO RELATED APPLICATION(S)

This application is based on and claims priority under 35 U.S.C. § 119 to Korean Patent Application No. 10-2023-0023609 filed on Feb. 22, 2023, and Korean Patent Application No. 10-2023-0010076 filed on Jan. 26, 2023, in the Korean Intellectual Property Office, the disclosures of which are incorporated herein by reference in their entirety.

### BACKGROUND

### 1. Field

The present disclosure relates to a neural network computing system and a method of executing a neural network model.

### 2. Description of Related Art

Recently, research into a neural network mimicking a learning ability of a human brain to process information has been actively conducted. Using a neural network-based operation, an object or specific information may be accurately recognized and identified from various types of user data such as voice data, image data, and video data.

A processor may include heterogeneous computing devices. Heterogeneous computing devices may include a central processing unit (CPU) having high versatility, and a neural processing unit (NPU) optimized for neural network computation. To perform neural network computations, NPUs and also computing devices such as CPUs may be used together. When neural network computation is performed using various hardware devices including heterogeneous calculation devices, power consumption may increase.

### SUMMARY

Provided are a neural network computing system that may reduce power consumption of hardware devices while allowing neural network models to be executed within a target runtime, and a method of executing a neural network model.

According to an aspect of the disclosure, a neural network computing system includes: a processor comprising a plurality of computing devices: a memory storing at least one instruction related to execution of a neural network model: a memory controller configured to control data input/output of the memory; and a system bus configured to support communication between the processor and the memory controller, where the processor is configured to execute the at least one instruction to: determine a normalized target performance of the neural network model by performing feedback control based on an error of a target execution time and an actual execution time of the neural network model, determine a normalized target performance of each of the plurality of computing devices based on the normalized target performance of the neural network model and a proportion of execution time of each of the plurality of computing devices, determine a normalized target performance of the memory controller and the system bus based on the normalized target performance of the neural network model, determine an operating frequency for each of a plurality of hardware devices based on the normalized target performance of the plurality of computing devices, the memory controller, and the system bus, the plurality of hardware devices comprising the plurality of computing devices, the memory controller, and the system bus, and execute the neural network model by operating the plurality of hardware devices based on the determined operating frequency for each of the plurality of hardware devices.

According to an aspect of the disclosure, a neural network computing system includes: a processor comprising a plurality of computing devices: a memory storing at least one instruction related to execution of a plurality of neural network models: a memory controller configured to control data input/output of the memory; and a system bus configured to support communication between the processor and the memory controller, where the processor is configured to execute the at least one instruction to execute: a plurality of frequency determiners corresponding to a plurality of neural networks, each frequency determiner configured to determine a plurality of operating frequencies for each of a plurality of hardware devices by performing feedback control based on an error of a target execution time and an actual execution time of the corresponding neural network model, and an execution time of each node and each edge of the corresponding neural network model, the plurality of hardware devices comprising the plurality of computing devices, the memory controller, and the system bus, a system frequency determiner configured to determine a highest value from the plurality of operating frequencies for each hardware device as a system operating frequency for each of the plurality of hardware devices, and a neural network model executor configured to execute the plurality of neural network models by controlling the plurality of hardware devices according to the system operating frequency determined for each of the plurality of hardware devices, and output the actual execution time of the plurality of neural network models and the execution time of each node and each edge of the plurality of neural network models.

According to an aspect of the disclosure, a method of executing a neural network model includes: triggering frequency scaling of a neural network model in response to a trigger of the neural network model: determining a target performance of the neural network model based on an error between a target execution time of the neural network model and a previous actual execution time of the neural network model; determining, with respect to a plurality of heterogeneous computing devices configured to execute the neural network model, a target performance for each heterogeneous computing device based on the target performance of the neural network model and an execution time of each node and each edge of the neural network model: determining an operating frequency for each heterogeneous computing device to execute the neural network model based on the target performance for each heterogeneous computing device: setting a system operating frequency for each heterogeneous computing device based on a plurality of operating frequencies determined for each heterogeneous computing device for executing a plurality of neural network model being executed including the neural network model; and executing the neural network model according to the system operating frequency for each heterogeneous computing device.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a block diagram illustrating a neural network computing system according to an embodiment:

FIGS. 2A-2D are graphs illustrating an execution time of a neural network model according to operating frequencies of hardware devices according to an embodiment:

FIG. 3 is a diagram illustrating a configuration of a neural network model according to an embodiment:

FIG. 4 is a block diagram illustrating a neural network computing system according to an embodiment:

FIG. 5 is a block diagram illustrating a hierarchical structure of a neural network computing system according to an embodiment;

FIG. 6 is a block diagram illustrating a system software layer of a neural network computing system in detail according to an embodiment;

FIG. 7 is a diagram illustrating an example in which commands of a neural network model are classified into commands of each hardware device according to an embodiment;

FIG. 8 is a graph illustrating normalized target performance of computing devices according to normalized target performance of a neural network model and a proportion of execution time of computing devices according to an embodiment;

FIG. 9 is a diagram illustrating a method of analyzing a proportion of execution time using a directed acyclic graph of a neural network model according to an embodiment;

FIG. 10 is a diagram illustrating an execution time of a neural network model and an execution time of each computing device in a longest path according to an embodiment;

FIG. 11 is a diagram illustrating a method of determining an operating frequency based on target performance for each hardware device according to an embodiment;

FIG. 12 is a diagram illustrating a method of executing a neural network model according to an embodiment;

FIG. 13 is a diagram illustrating a neural network computing system according to an embodiment; and

FIG. 14 is a diagram illustrating an electronic device to which a network computation system is applied according to an embodiment.

### DETAILED DESCRIPTION

Hereinafter, embodiments of the present disclosure will be described as follows with reference to the accompanying drawings, where like reference numerals refer to like elements throughout. The embodiments described herein are example embodiments, and thus, the disclosure is not limited thereto and may be realized in various other forms.

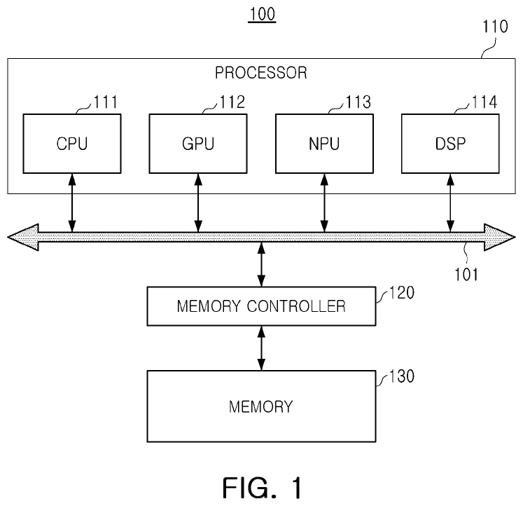

FIG. 1 is a block diagram illustrating a neural network computing system according to an embodiment.

FIG. 1 illustrates a neural network computing system 100. The neural network computing system 100 may execute a neural network model. A neural network model may model a learning method in which a human brain processes information, and may refer to a model of accurately recognizing and discriminating an object or specific information from various user data such as voice, images, and videos.

The neural network computing system 100 may be implemented as a mobile system such as a mobile phone, a smartphone, a tablet personal computer (PC), a wearable device, a healthcare device, or an Internet of Things (IoT) device. However, the neural network computing system 100 is not necessarily limited to a mobile system, and may implemented as a personal computer, a laptop computer, a server, a media player, or an automotive device such as navigation device.

The neural network computing system 100 may include a plurality of hardware devices such as a processor 110, a memory controller 120, a memory 130, and a system bus 101. The system bus 101 may support communication between the processor 110, the memory controller 120 and the memory 130.

The processor 110 may perform neural network computation using data stored in the memory 130. For example, neural network computation may include an operation of reading data and weights of each node included in the neural network model, performing convolutional computation of the data and weights, and storing or outputting computing results.

The memory 130 may store data necessary for the processor 110 to perform neural network computation. For example, one or more neural network models which may be executed by the processor 110 may be loaded into the memory 130. Also, the memory 130 may store input data and output data of the neural network model. The memory 130 may include a volatile memory such as a dynamic random access memory (DRAM), a synchronous DRAM (SDRAM), a static RAM (SRAM), and a non-volatile memory such as a flash memory.

The memory controller 120 may control an operation of storing data received from the processor 110 in the memory 130 and an operation of outputting the data stored in the memory 130 to the processor 110. The memory controller 120 may include at least one of a plurality of logic circuits such as a memory interface logic, an address decoder, a command sequencer, a data buffer, an error detection and correction logic, a power management logic, etc., not being limited thereto.

The processor 110 may include heterogeneous computing devices performing data processing and computation, such as a central processing unit (CPU) 111, a graphic processing unit (GPU) 112, a neural processing unit (NPU) 113, and a digital signal processor (DSP) 114.

Specifically, the CPU 111 may be a computing device having high versatility. The GPU 112 may be a computing device optimized for parallel computing such as graphics processing. The NPU 113 may be a computing device optimized for neural network computation, and may include logic blocks for executing unit computation mainly used in neural network computation, such as convolutional computation. The DSP 115 may be a computing device optimized for real-time digital processing of analog signals.

When the processor 110 executes the neural network model, various hardware devices may operate together. For example, in order to execute a neural network model, heterogeneous computing devices such as the NPU 113 and also the CPU 111, the GPU 112, and the DSP 114 may operate together. Also, the memory controller 120 and the system bus 101 may operate to read input data of the neural network model and to store output data.

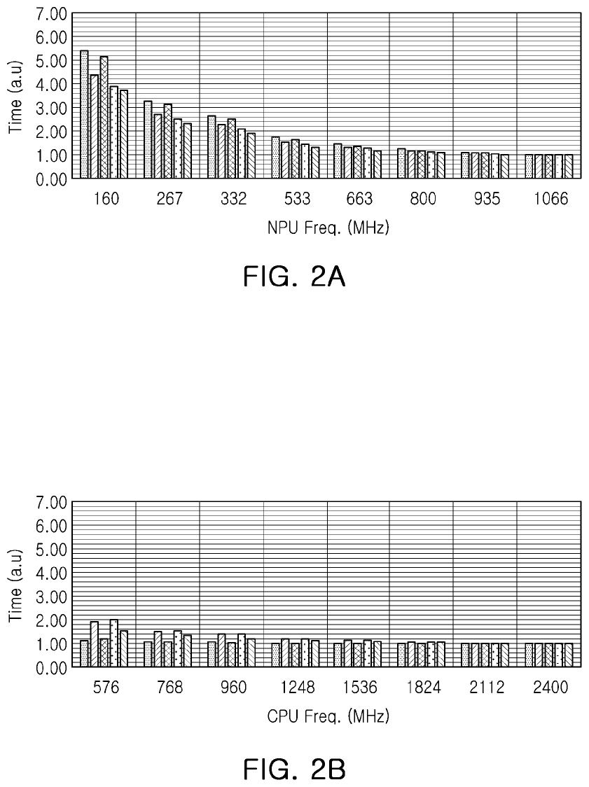

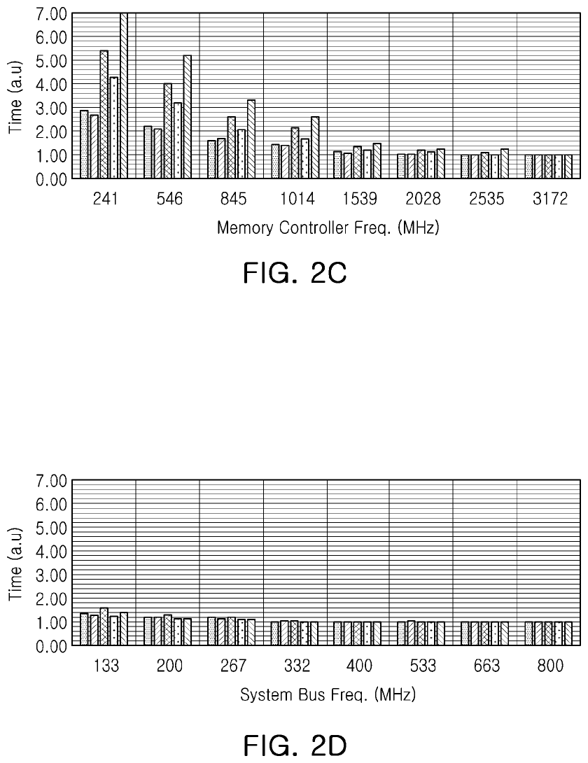

FIGS. 2A-2D are graphs illustrating an execution time of a neural network model according to operating frequencies of hardware devices. (a.u.) in the graphs represents an arbitrary unit for time.

The graph in FIG. 2A indicates a standardized execution time of the neural network model according to an operating frequency of the NPU 113. The execution time of the neural network model may refer to the time taken for the neural network model to receive data and to complete processing of the data.

In FIG. 2A, the standardized execution time may refer to a standardized execution time of the neural network model according to the operating frequency of the NPU 113 by setting, to “1,” the execution time required when a neural network model is executed while each hardware device such as the CPU 111, the GPU 112, the NPU 113, and the DSP 114, the memory controller 120, the system bus 101 operates at the highest operating frequency. For example, the operating frequency of hardware devices may be discretely adjusted according to binary code values, and may include the lowest operating frequency and the highest operating frequency among the operating frequencies which each hardware device may have. In the example in FIG. 2A, the NPU 113 may have the lowest operating frequency of 160 MHz and the highest operating frequency of 1066 MHZ. In FIG. 2A, a plurality of bar graphs illustrated in different patterns for each operating frequency of the NPU 113 may represent execution times of different neural network models.

Referring to the graph in FIG. 2A, as the operating frequency of the NPU 113 increases in each of the different neural network models, the standardized execution time may tend to gradually decrease. That is, the execution time of the neural network model may be affected by the operating frequency of the NPU 113.

The graph in FIG. 2B indicates the standardized execution time of the neural network model according to the operating frequency of the CPU 111. In FIG. 2B, the standardized execution time may refer to a standardized execution time of the neural network model according to the operating frequency of the CPU 111 by setting, to “1,” the execution time required when the neural network model is executed while each hardware device operates at the highest operating frequency. The graph in FIG. 2B indicates a tendency that the standardized execution time gradually decreases as the operating frequency of the CPU 111 increases. That is, the execution time of neural network models may be affected by the operating frequency of the NPU 113 and also the operating frequency of the CPU 111.

The graph in FIG. 2C indicates the standardized execution time of the neural network model according to the operating frequency of the memory controller 120. In FIG. 2C, the standardized execution time may refer to a standardized execution time of the neural network model according to the operating frequency of the memory controller 120 by setting, to “1,” the execution time required when the neural network model is executed while operating at the highest operating frequency. The graph in FIG. 2C indicates a tendency that the standardized execution time of neural network models gradually decreases as the operating frequency of the memory controller 120 increases.

The graph in FIG. 2D indicates the standardized execution time of the neural network model according to the operating frequency of the system bus 101. In FIG. 2C, the standardized execution time may refer to a standardized execution time of the neural network model according to the operating frequency of the memory controller 120 by setting, to “1,” the execution time required when the neural network model is executed while operating at the highest operating frequency. The graph in FIG. 2D indicates a tendency that the standardized execution time of neural network models gradually decreases as the operating frequency of the memory controller 120 increases.

Referring to FIGS. 2C and 2D, the execution time of the neural network model may be affected by the operating frequency of heterogeneous computing devices such as NPU 113 and CPU 111, and also the operating frequency of other hardware devices such as the memory controller 120 and the system bus 101.

To guarantee user-experienced performance of the neural network computing system 100, a target execution time may be determined for each neural network model. For example, a target execution time of 10 ms may be determined for a neural network model for receiving an image frame from a camera application of the neural network computing system 100 and detecting an object. A target execution time of 15 ms may be determined for the neural network model for identifying what the object is. In order to execute the neural network models within the target execution time, heterogeneous computing which may accelerate the execution of neural network models through heterogeneous computing devices such as the NPU 113 and also the CPU 111, the GPU 112, and the DSP 115 may be required.

When hardware devices simultaneously operate at the highest operating frequency to execute the neural network model, power consumption may increase. In order to reduce power consumption of the neural network computing system 100, a dynamic voltage frequency scaling (DVFS) mechanism for dynamically scaling an operation voltage and an operating frequency has been suggested. For example, the governor of the Linux kernel may predict a future usage rate based on a past usage rate of each heterogeneous computing device and may determine an operating frequency based on the predicted future usage rate.

However, when the neural network computing system determines the operating frequency based on the usage rate of each heterogeneous computing device without considering the target execution time of the neural network model, the neural network computing system may be difficult to comply with the target execution time of a neural network model. That is, user responsiveness, which is properties of providing a response to a user by completing the neural network model within the target execution time, may deteriorate.

Also, a system, such as a governor, may determine the operating frequency by receiving feedback from the past usage rate, but the system may operate regardless of whether the neural network model is executed, and the feedback cycle may be several to several tens of times the execution time of the neural network model. It may be difficult for a system performing operating frequency control by receiving belated feedback after completing the execution of the neural network model to instantly control the power consumption due to the execution of the neural network model.

According to an embodiment, the neural network computing system 100 may perform feedback control for the operating frequency of hardware devices for executing the neural network model based on the error of the target execution time and the actual execution time of a neural network model. For example, when the neural network computing system 100 starts executing the neural network model, the operating frequency of the hardware devices may be controlled instantly, and the operating frequency values may be determined by feedback control based on an error of the execution time when the neural network model is previously executed. The neural network computing system 100 according to an embodiment may reduce power consumption while improving user responsiveness.

Before specifically describing the neural network computing system 100 according to an embodiment, the configuration of a neural network model will be described in greater detail.

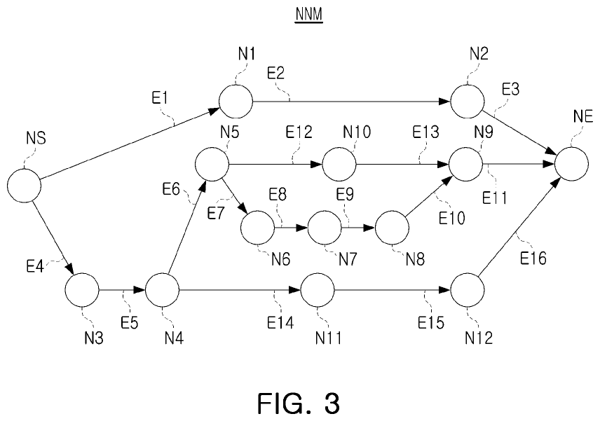

FIG. 3 is a diagram illustrating a configuration of a neural network model.

Referring to FIG. 3, the neural network model NNM may include a plurality of nodes NS, N1-N12, and NE, and a plurality of edges E1-E16. The neural network model NNM may be represented as a directed acyclic graph. A directed acyclic graph may refer to a graph structured in a structure in which individual elements are directed in a specific direction and do not cycle with each other.

Each of the plurality of nodes NS, N1-N12, and NE may be obtained by modeling a neuron as a basic unit of a nervous system. Each of the plurality of nodes NS, N1-N12, and NE may include source codes instructing computations to be executed. The plurality of nodes NS, N1-N12, and NE may be executed on one of the heterogeneous computing devices included in the processor. The plurality of nodes NS, N1-N12, and NE may further include an attribute value indicating a target computing device on which source codes is to be executed.

The plurality of nodes NS, N1-N12, and NE may include a start node NS, first to twelfth nodes N1-N12, and an end node NE. The start node NS may be a node receiving external input data for the execution of the neural network model. The final node NE may be a node outputting resultant data to an external entity after execution of the neural network model is completed. The first to twelfth nodes N1-N12 may be for generating result data based on input data.

The input/output relationship between the plurality of nodes NS, N1-N12, and NE may be represented as a plurality of edges E1-E16. For example, the second edge E2 may represent a relationship in which data output from the first node N1 is input to the second node N2. For example, when the CPU 111 executes the first node N1 and the NPU 113 executes the second node N2, the CPU 111 may store the output data in the memory 130 through the memory controller 120 by completing computation of the first node N1. The NPU 113 may obtain the data stored in the memory 130 through the memory controller 120 and may execute the second node N2 using the obtained data.

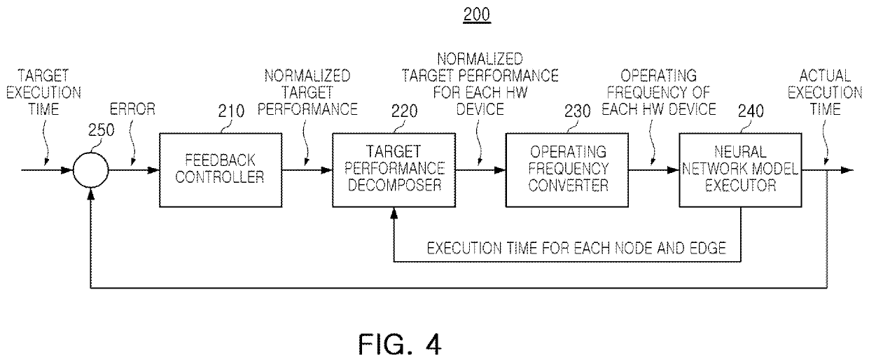

According to an embodiment, the neural network computing system 100 may analyze a proportion of execution time of computing devices executing the plurality of nodes NS, N1-N12, and NE, and may determine target performance for each computing device based on the proportion of execution time for each computing device. The neural network computing system 100 may control the operating frequency of hardware devices including heterogeneous computing devices based on the target performance for each computing device. Hereinafter, the neural network computing system according to an embodiment will be described in greater detail with reference to FIGS. 4-13.

FIG. 4 is a block diagram illustrating a neural network computing system according to an embodiment.

Referring to FIG. 4, the neural network computing system 200 may include a feedback controller 210, a target performance decomposer 220, an operating frequency converter 230, a neural network model executor 240, and an error calculator 250. The neural network computing system 200 in FIG. 4 may correspond to the neural network computing system 100 in FIG. 1. The feedback controller 210, the target performance decomposer 220, the operating frequency converter 230, the neural network model executor 240, and the error calculator 250 may be implemented in software, and may be performed by hardware devices as described with reference to FIG. 1.

The neural network model executor 240 may control the operating frequency of hardware devices included in the neural network computing system 200 based on the control signal output from the operating frequency converter 230, and may control hardware devices to execute the neural network model while operating according to the operating frequency. The neural network model executor 240 may feedback the actual execution time of the neural network model to the error calculator 250.

The error calculator 250 may obtain the actual execution time from the neural network model executor 240 and may calculate an error between the target execution time of the neural network model input from an external entity and the actual execution time.

The feedback controller 210 may perform feedback control for determining normalized target performance based on the error of execution time obtained from the error calculator 250. The normalized target performance may be target performance represented as a relative value based on the highest performance which may be exhibited when each hardware device of the neural network computing system 200 operates at the highest operating frequency and the lowest performance which may be exhibited when each hardware device operates at the lowest operating frequency. For example, the feedback controller 210 may set the highest performance value to “1,” may set the lowest performance value to “0,” and may determine the normalized target performance to have a value of 0 to 1.

The feedback controller 210 may control the actual execution time to be close to the target execution time by adjusting normalized target performance downwardly when it is determined that the actual execution time is shorter than the target execution time based on the error of the execution time, and adjusting the normalized target performance upward when it is determined that the actual execution time is greater than the target execution time. In an embodiment, the feedback controller 210 may adjust the normalized target performance to a large extent as the execution time error increases.

The target performance decomposer 220 may decompose the normalized target performance obtained from the feedback controller 210 into normalized target performance for each hardware device. For example, the target performance decomposer 220 may obtain the execution time of each node and each edge of the neural network model from the neural network model executor 240, may determine a proportion of execution time for each hardware device by analyzing the execution time for each node and edge, and may determine normalized target performance for each hardware device based on the proportion of execution time. For example, the target performance decomposer 220 may determine the normalized target performance to be a lower value for a hardware device having a lower proportion of execution time.

The operating frequency converter 230 may convert the normalized target performance for each hardware device obtained from the target performance decomposer 220 into an operating frequency for each hardware device. For example, the operating frequency converter 230 may select an operating frequency value proportional to the normalized target performance for each hardware device in the range of the highest operating frequency and the lowest operating frequency for each hardware device. The operating frequency converter 230 may provide a control signal including an operating frequency value of each hardware device to the neural network model executor 240.

According to an embodiment, the neural network computing system 200 may perform feedback control for the operating frequency of hardware devices executing the neural network model based on the target execution time and the actual execution time of the neural network model, thereby reducing power consumption to the extent that the target execution time of the neural network model is guaranteed. Accordingly, the neural network computing system 200 may reduce power consumption due to the execution of the neural network model while ensuring user responsiveness.

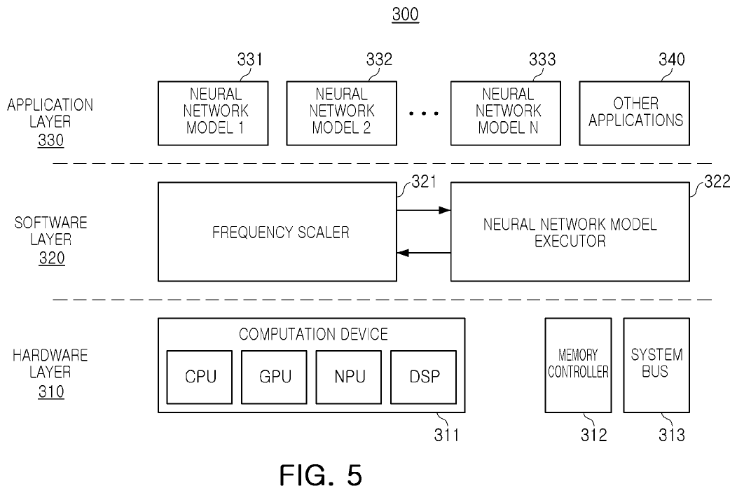

FIG. 5 is a block diagram illustrating a hierarchical structure of a neural network computing system according to an embodiment.

The neural network computing system 300 may have a hierarchical structure including a hardware layer 310, a system software layer 320, and an application layer 330.

The hardware layer 310 may be the lowest layer of the neural network computing system 300, and may include hardware devices such as a processor 311, a memory controller 312, and a system bus 313. The processor 311 may include heterogeneous computing devices such as a CPU, a GPU, an NPU, and a DSP. The hardware devices included in the hardware layer 310 in FIG. 5 may correspond to hardware devices of the neural network computing system 100 described with reference to FIG. 1. However, the memory for inputting and outputting data under control of the memory controller 312 may not be provided in FIG. 5.

The system software layer 320 may manage hardware devices of the hardware layer 310 and may provide an abstract platform. For example, the system software layer 320 may drive a kernel such as Linux.

The system software layer 320 may include a frequency scaler 321 and a neural network model executor 322. According to an embodiment, the frequency scaler 321 may determine an operating frequency of hardware devices executing a neural network model by performing feedback control.

The neural network model executor 322 may execute the neural network model using hardware devices operating at an operating frequency determined by the frequency scaler 321. The neural network model executor 322 may output the actual execution time of the neural network model as a result of executing the neural network model. The actual execution time may be feedbacked to the frequency scaler 321 for closed loop control of the frequency scaler 321.

The system software layer 320 may be executed by the processor 311. For example, the system software layer 320 may be executed by a CPU. However, the computing device on which the system software layer 320 may be driven is not limited to a CPU.

The application layer 330 may be executed in the system software layer 320 and may include a plurality of neural network models 331-333 and other applications 340. For example, the other applications 340 may include a camera application. A plurality of neural network models 331-333 may include a model for detecting an object included in an image frame obtained by a camera application, a model for identifying what the detected object is, a model for detecting a target area in the image frame, a model for identifying the detected target area, and a model for classifying the identified target area according to meaning such as a person, a car, or a tree. However, the types of neural network models 331-333 and other applications 340 are not limited thereto.

According to an embodiment, the system software layer 320 may receive feedback of an error of each target execution time and the actual execution time of the neural network models 331-333 in order to execute the neural network models 331-333, and may control the operating frequency of hardware devices based on the error of the execution time. When the neural network model is executed, other applications may be simultaneously executed, and a plurality of neural network models may be simultaneously executed. For example, when the neural network computing system 300 is a mobile system, a neural network model for detecting an object may be executed simultaneously with executing a camera application. When a plurality of applications, including neural network models, are executed simultaneously, resource contention may occur in the hardware devices.

According to an embodiment, the system software layer 320 may adjust the operating frequency of the hardware devices based on the target execution time and the actual execution time of each of the multiple neural network models simultaneously executed among the neural network models 331-333. According to an embodiment, the neural network computing system 300 may obtain a target execution time of a plurality of neural network models while reducing power consumption of the hardware devices.

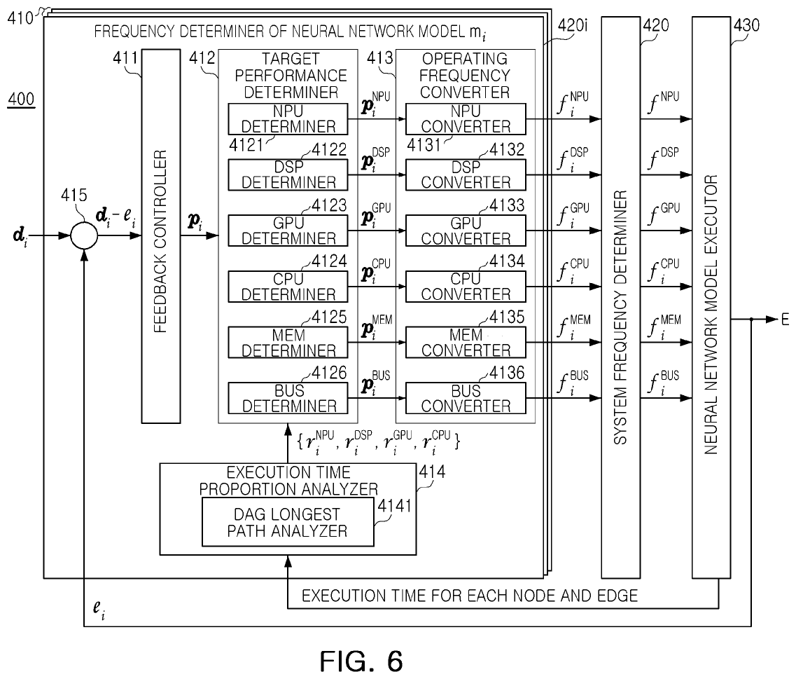

FIG. 6 is a block diagram illustrating a system software layer of a neural network computing system in detail according to an embodiment.

Referring to FIG. 6, the system software layer of a neural network computing system 400 may include a plurality of frequency determiners 410, a system frequency determiner 420, and a neural network model executor 430. The plurality of frequency determiners 410 may correspond to the neural network models being executed, respectively. FIG. 6 illustrates a frequency determiner 410i of an arbitrary neural network model mᵢ among the neural network models being executed. The plurality of frequency determiners 410 and the system frequency determiner 420 in FIG. 6 may correspond to the frequency scaler 421 in FIG. 5, and the neural network model executor 430 of FIG. 6 may correspond to the neural network model executor 422 of FIG. 5.

Referring to FIG. 6, the plurality of frequency determiners 410 may output operating frequencies fᵢ^{NPU}, fᵢ^{CPU}, fᵢ^{GPU}, fᵢ^{DSP}, fᵢ^{MEM}, and fᵢ^{BUS} for each hardware device to execute the neural network model based on an error dᵢ-eᵢ between the target execution time dᵢ and the actual execution time eᵢ of the corresponding neural network model.

The system frequency determiner 420 may obtain operating frequencies for each hardware device for executing each neural network model from each of the plurality of frequency determiners 410. The system frequency determiner 420 may output system operating frequencies f^{NPU}, f^{CPU}, f^{GPU}, f^{DSP}, f^{MEM}, and f^{BUS} for each hardware device for simultaneously executing a plurality of neural network models including neural network model mᵢ. For example, the system frequency determiner 420 may determine the highest value of the operating frequency for each hardware device as a system operating frequency for each hardware device among the operating frequencies for each hardware device obtained from each of the plurality of frequency determiners 410. For example, the system frequency determiner 420 may determine the highest value among operating frequencies of the NPU obtained from each of the plurality of frequency determiners 410 as the system operating frequency of the NPU.

The neural network model executor 430 may control the operating frequency of hardware devices based on the system operating frequency obtained from the system frequency determiner 420, and may execute a plurality of neural network models using the hardware devices. The neural network model executor 430 may output execution times E of the plurality of neural network models.

The frequency determiner 410i of the neural network model mᵢ may include a feedback controller 411, a target performance determiner 412, an operating frequency converter 413, an execution time proportion analyzer 414, and an error calculator 415. The feedback controller 411, the operating frequency converter 413, and the error calculator 415 in FIG. 6 may correspond to the feedback controller 210, the operating frequency converter 230, and the error calculator 415 in FIG. 4, respectively. The target performance determiner 412 and the execution time proportion analyzer 414 in FIG. 6 may correspond to the target performance decomposer 220 in FIG. 4.

The feedback controller 411 may output the normalized target performance pᵢ of the neural network model mᵢ by performing feedback control based on the error dᵢ-eᵢ of the execution time of the neural network model mᵢ.

A target execution time of the neural network model mᵢ may be determined in advance. For example, a device driver for controlling hardware devices may provide an application programming interface (API) for setting target execution time of each neural network model. Target execution time of each neural network model may be input through the API.

According to an embodiment, the feedback controller 411 may determine an initial value of normalized target performance of a predetermined neural network model as “1,” That is, the feedback controller 411 may ensure user responsiveness by controlling each hardware device to operate according to the highest operating frequency when a predetermined neural network model is first executed. The feedback controller 411 may control the actual execution time to converge to the target execution time while adjusting the normalized target performance downward based on the actual execution time smaller than the target execution time.

The target performance determiner 412 may output normalized target performance pᵢ^{NPU}, pᵢ^{DSP}, pᵢ^{GPU}, pᵢ^{CPU}, pᵢ^{MEM}, and pᵢ^{BUS} for each hardware device based on the normalized target performance pᵢ output from the feedback controller 411 and the proportions of execution time rᵢ^{NPU}, rᵢ^{DSP}, rᵢ^{GPU}, and rᵢ^{CPU} for each computing device. FIG. 6 illustrates an NPU determiner 4121, a DSP determiner 4122, a GPU determiner 4123, a CPU determiner 4124, a memory controller determiner 4125, and a system bus determiner 4126 for determining normalized target performance for each hardware device.

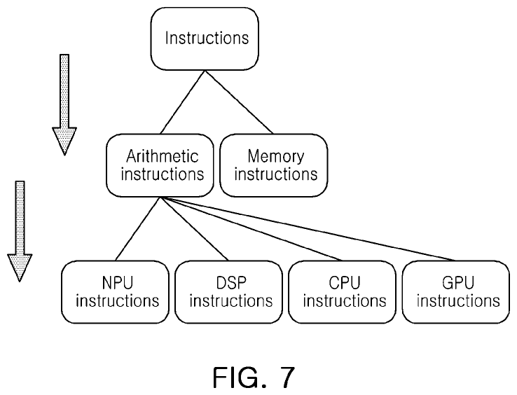

The execution time proportion analyzer 414 may determine a proportion of execution time of each computing device based on the execution time of each node and each edge of the neural network model output from the neural network model executor 430. FIG. 6 illustrates a DAG longest path analyzer 4141 determining the proportion of execution time of each computing device based on the longest path of the directed acyclic graph (DAG). The method of determining the proportion of execution time of each computing device by the execution time proportion analyzer 414 and the method of determining the normalized target performance for each hardware device by the target performance determiner 412 will be described later with reference to FIGS. 7-9.

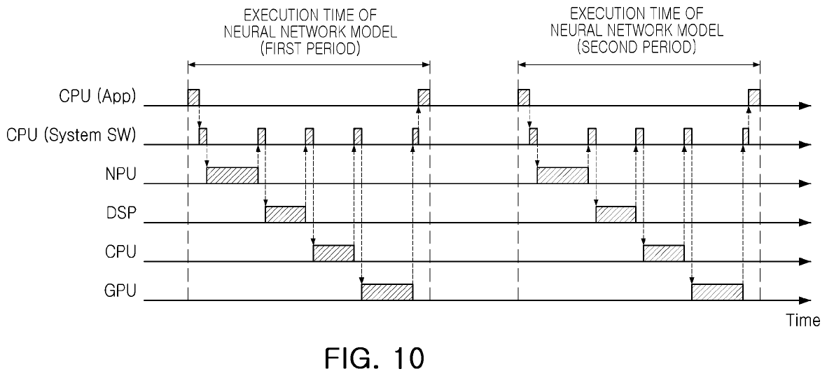

The operating frequency converter 413 may output operating frequencies fᵢ^{NPU}, fᵢ^{DSP}, fᵢ^{GPU}, fᵢ^{CPU}, fᵢ^{MEM}, and fᵢ^{BUS} for each hardware device for executing the neural network model mᵢ based on the normalized target performance for each hardware device obtained from the target performance determiner 412. FIG. 6 illustrates an NPU converter 4131, a DSP converter 4132, a GPU converter 4133, a CPU converter 4134, a memory controller converter 4135, and a system bus converter 4136 for determining the operating frequency for each hardware device. A method of determining the operating frequency for each hardware device by the operating frequency converter 413 will be described later with reference to FIG. 10.

FIG. 7 is a diagram illustrating an example in which commands of a neural network model are classified into commands of each hardware device.

The neural network model may be executed by processing a plurality of instructions included in the neural network model. Referring to FIG. 7, instructions to be performed to execute the neural network model may be classified as arithmetic instructions and memory instructions. Arithmetic instructions may refer to instructions used by a computing device to perform mathematical computations such as addition, subtraction, multiplication, and division. Memory instructions may refer to instructions used by a computing device to access memory. Each node of the neural network model may include arithmetic instructions and may further include memory instructions. Each edge of the neural network model may include memory instructions.

The arithmetic instructions may be classified into NPU instructions, DSP instructions, CPU instructions, and GPU instructions. The memory instructions may be classified into memory controller instructions and system bus instructions.

When operating frequencies differ greatly between hardware devices having dependencies on each other in terms of hardware structure, performance bottlenecks may occur. For example, when the operating frequency of the memory controller and the system bus is significantly lower than the operating frequency of computing devices, the memory controller and the system bus may not swiftly obtain values generated from computing devices and it may be difficult to swiftly provide values required from computing devices.

According to an embodiment, the operating frequency of the memory controller and system bus may be interlocked with the operating frequency of computing devices. For example, by determining the normalized target performance of the memory controller and system bus as the same value as the highest target performance among the normalized target performances of computing devices, operating frequencies may be interlocked.

Also, relatively significantly lowering the operating frequency of a computing device with a relatively low proportion of execution time among computing devices may affect less on the overall execution time of the neural network model and may contribute to reducing the amount of power consumed while executing the neural network model.

According to an embodiment, an operating frequency for each computing device may be determined based on a proportion of execution time of a neural network model of each computing device. Specifically, the normalized target performance of a computing device may be determined in inverse proportion to the proportion of execution time of each computing device. For example, the normalized target performance of an arbitrary computing device PU may be determined based on [Equation 1] as below:

$${p}_{i}^{P U} = max ( 1 - ( 1 - {p}_{i} ) \cdot \frac{{r}_{i}^{Max}}{{r}_{i}^{P U}} , 0 ) \qquad [ Equation 1 ]$$

In the equation, pᵢ^{PU} represents normalized target performance of an arbitrary computing device, pᵢ represents normalized target performance of the neural network model, rᵢ^{PU} represents a proportion of execution time of an arbitrary computing device, and rᵢ^{Max} represents the highest value of a proportion of execution time of the computing devices. That is,

$$\frac{{r}_{i}^{Max}}{{r}_{i}^{P U}}$$

may represent a value inversely proportional to the proportion of execution time of an arbitrary computing device PU. The arbitrary computing device PU may be one of an NPU, a DPS, a GPU, and a CPU.

To determine the normalized target performance of a predetermined computing device as “0” may be to determine an operating frequency value of the computing device as “0,” but the configuration does not indicate that the computing device is not operated. To determine the normalized target performance of the computing device as “0” may indicate that the amount of computing to be performed in the computing device to execute the neural network model may be sufficiently small, and that the operating frequency value of the computing device may be determined to be the lowest frequency value in the specified range.

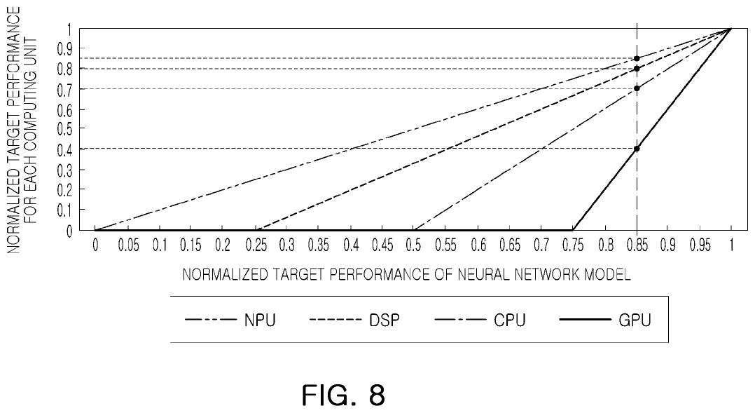

FIG. 8 is a graph illustrating normalized target performance of computing devices according to normalized target performance of a neural network model and a proportion of execution time of computing devices.

In the graph in FIG. 8, the horizontal axis represents the normalized target performance of the neural network model, and the vertical axis represents the normalized target performance of the computing devices. FIG. 8 indicates normalized target performance of each computing device determined according to [Equation 1] based on the normalized target performance of the neural network model in the example in which the proportions of execution time of computing devices NPU, DPS, CPU, and GPU is 40%, 30%, 20%, and 10%, respectively.

Referring to FIG. 8, the normalized target performance of the NPU having the highest value for the proportion of execution time may be determined to be the same value as the normalized target performance of the neural network model.

The normalized target performance of a CPU of which a proportion of execution time is half that of the NPU may change twice as steeply as the normalized target performance of the NPU when the normalized target performance of the neural network model is 0.5 to 1. The normalized target performance of the CPU may be determined to be “0” when the normalized target performance of the neural network model is 0 to 0.5. That is, when the normalized target performance of the neural network model is 0 to 0.5, the amount of computing to be performed in the CPU may be sufficiently small to execute the neural network model, the normalized target performance in the CPU may be determined to be “0.” Similarly, when the normalized target performance of the neural network model is below a predetermined value, the normalized target performance of the DSP and GPU may be determined to be “0.”

The normalized target performance of a memory controller and a system bus not illustrated in FIG. 8 may be determined to be the same value as the normalized target performance of the NPU. In the example in FIG. 8, when the normalized target performance of the neural network model is 0.85, the normalized target performance of the NPU, the memory controller, and the system bus may be determined to be 0.85, and the normalized target performance of the DSP, CPU, and GPU may be determined to be about 0.8, 0.7, and 0.4, respectively.

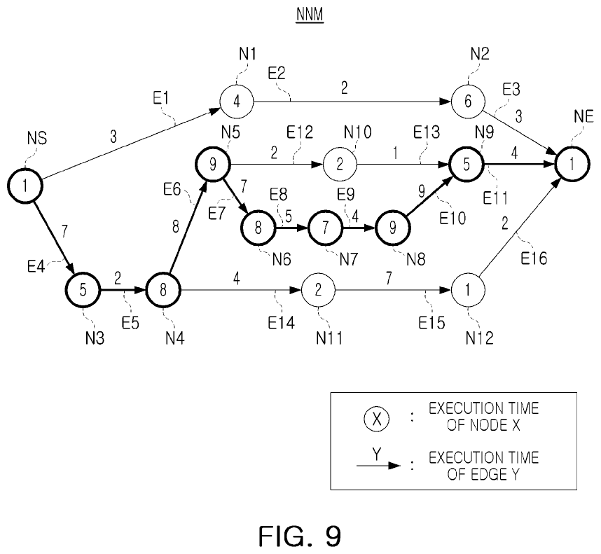

Hereinafter, with reference to FIGS. 9 and 10, a method of analyzing the proportion of execution time of each computing device will be described in greater detail.

FIG. 9 is a diagram illustrating a method of analyzing a proportion of execution time using a directed acyclic graph of a neural network model.

FIG. 9 indicates an execution time of each node and an execution time of each edge in the neural network model NNM described with reference to FIG. 3. For example, the execution time of the first node N1 may be “4” and the execution time of the first edge E1 may be “3.” The execution time values may be relative values having arbitrary units.

Among a plurality of nodes NS, N1-N12, and NE, nodes having dependencies may be processed in a predetermined order. Dependency between nodes may refer to a relationship in which an output value of a node is used as an input value of another node. For example, the fifth node N5 may use an output value from the fourth node N4 as an input value. The sixth node N6 may use an output value of the fifth node N5 as each input value. That is, the fifth node N5 may have a dependency on the fourth node N4, and the sixth node N6 may have a dependency on the fifth node N5. Between the fourth and sixth nodes N4, N5, and N6, the fourth node N4, fifth node N5, and sixth node N6 may need to be processed in order.

The nodes having independence may not be processed in a predetermined order, and may be processed in parallel. For example, the sixth node N6 and the tenth node N10 may not have a relationship in which output values thereof may be used as input values. Accordingly, the sixth node N6 and the tenth node N10 may be processed in any order, and may be processed in parallel.

The directed acyclic graph of neural network model NNM may have various paths from the start node NS to the end node (ES) due to dependencies and independence of the nodes.

The execution time of the neural network model may depend on the execution time of the longest path taking the longest execution time among various paths. For example, the execution time of the neural network model may be the same as the execution time of the longest path. According to an embodiment, a proportion of execution time of each computing device may be determined based on analysis of the longest path of a directed acyclic graph. The DAG longest path analyzer 4141 illustrated in FIG. 6 may determine the longest path with the largest execution time among various directional acyclic paths of the neural network model based on the execution time of each node and each edge obtained from the neural network model executor 430. In the example in FIG. 9, the longest path of the neural network model NNM is marked a relatively thick line.

FIG. 10 is a diagram illustrating an execution time of a neural network model and an execution time of each computing device in a longest path.

FIG. 10 illustrates an execution period of computing devices in a first period and a second period in which the same neural network model is executed. The first period and the second period may coincide with the execution time of the neural network model.

Execution time of computing devices in the first period may be determined based on analysis of the longest path of the neural network model. The execution time of each of the nodes and edges included in the longest path may be obtained from the neural network model executor 430. A computing device on which each of the nodes and edges is executed may be determined in advance. Accordingly, the execution time of each computing device may be determined based on the execution time of each of the nodes and edges and the computing device in which each of the nodes and edges is executed.

A single neural network model may have a defined connection relationship between nodes and edges. Accordingly, the longest path in the first period and the second period may be the same. According to an embodiment, the target performance for each hardware device in the second period may be determined based on the execution time of the neural network model in the first period and the result of analysis of the longest path in the first period, and an operating frequency for each hardware device in the second period may be determined based on the target performance for each hardware device.

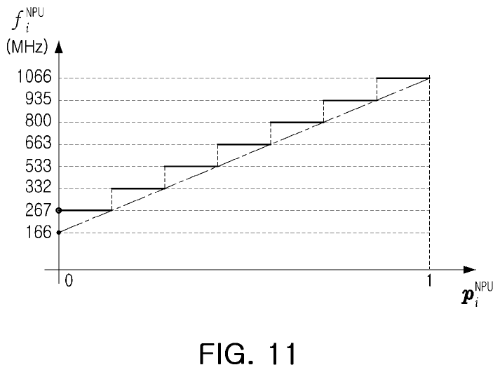

FIG. 11 is a diagram illustrating a method of determining an operating frequency based on target performance for each hardware device.

The operating frequency of an arbitrary computing device PU may be determined based on [Equation 2] as below:

$${f}_{i}^{P U} = ⌈ {p}_{i}^{P U} \cdot ( {f}_{Max}^{P U} - {f}_{Min}^{P U} ) + {f}_{Min}^{P U} ⌉ \qquad [ Equation 2 ]$$

In the equation, fᵢ^{PU} represents the operating frequency of the computing device PU for executing the neural network model mᵢ. pᵢ^{PU} represents the normalized target performance of the computing device PU to run the neural network model mᵢ, f_{Max}^{PU} represents the highest operating frequency which the computing device PU may have, and f_{Min}^{PU} represents the lowest operating frequency which the computing device PU may have.

Referring to [Equation 2], the operating frequency of the computing device PU may be determined based on a reference frequency proportional to the normalized target performance of the computing device PU within the range of the highest operating frequency and the lowest operating frequency of the computing device PU. The operating frequency of the computing device PU may be determined to be one of a plurality of previously determined discrete values. According to an embodiment, the operating frequency of the computing device PU may be determined to be a lowest value not smaller than a reference frequency value among the plurality of discrete values.

FIG. 11 is the graph indicating the relationship between the normalized target performance of an NPU for executing the neural network model mᵢ and the operating frequency of the NPU for executing the neural network model mᵢ, which is determined based on the normalized target performance. In the example in FIG. 11, the operating frequency of the NPU may be selected as one of 166 MHZ, 267 MHZ, 332 MHz, 533 MHZ, 663 MHZ, 800 MHz, 935 MHz, and 1006 MHz among a plurality of discrete values.

FIG. 11 illustrates a reference frequency value determined to be proportional to a normalized target performance PU between the lowest operating frequency and the highest operating frequency which an NPU may have, and an operating frequency value of a computing device PU determined based on the reference frequency value.

The amount of power consumed by the hardware device may be proportional to the square of the operating frequency of the hardware device. That is, as the operating frequency of the hardware device decreases, the amount of power consumed by the hardware device may decrease. Accordingly, the operating frequency for each hardware device may be reduced to the extent of guaranteeing the target execution time of the neural network model. Accordingly, power consumption of hardware devices may be reduced while complying with the target execution time of the neural network model.

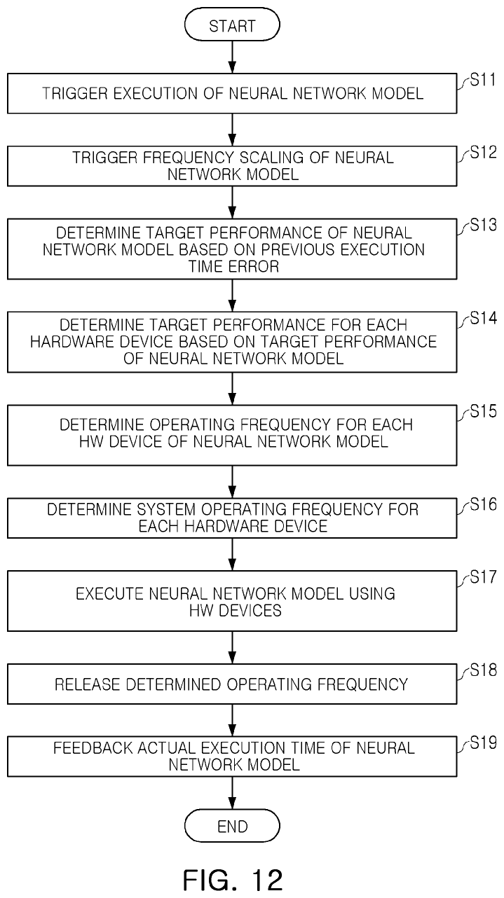

FIG. 12 is a diagram illustrating a method of executing a neural network model according to an embodiment.

In operation S11, an arbitrary neural network model may be triggered. For example, when a camera application is executed by a user selection, a neural network model for detecting an object may be triggered.

In operation S12, frequency scaling of the triggered neural network model may be triggered. For example, when the neural network model mᵢ is triggered, the frequency determiner 410i of the neural network model mᵢ as described with reference to FIG. 6 may be triggered together. The frequency determiner may be independently triggered for each neural network model. For example, a frequency determiner 410i may be further triggered in a state in which a frequency determiner of another neural network model is executed.

In operation S13, target performance of the neural network model may be determined based on a previous execution time error. For example, the feedback controller 411 as described with reference to FIG. 6 may determine an execution time error based on the target execution time of the neural network model and the previous execution time, and may determine the target performance of the neural network model based on the execution time error.

In operation S14, normalized target performance for each hardware device may be determined based on target performance of the neural network model. The target performance determiner 412 as described with reference to FIG. 6 may determine the normalized target performance of a computing device having the largest proportion of execution time among computing devices as the same value as the target performance of the neural network model. The normalized target performance of the other computing devices may be determined to be in inverse proportion to the normalized target performance of the computing device. The target performance determiner 412 may also determine the normalized target performance of the memory controller and system bus as the same value as the target performance of the neural network model.

In operation S15, an operating frequency for each hardware device of the neural network model m; may be determined based on the normalized target performance for each hardware device. The operating frequency converter 413 as described with reference to FIG. 6 may select a lowest value not smaller than a reference frequency value among a plurality of discrete operating frequency values, which may be selected for each hardware device. The reference frequency value may be determined based on target performance for each hardware device.

In operation S16, a system operating frequency for each hardware device may be determined based on operating frequencies for each hardware device of the neural network models being executed, including the triggered neural network model. For example, the system frequency determiner 420 described with reference to FIG. 6 may determine the highest value among operating frequencies of executing neural network models as the system operating frequency for each hardware device.

In operation S17, the triggered neural network model may be executed by driving hardware devices according to the determined system operating frequency.

In operation S18, when execution of the triggered neural network model is completed, the determined operating frequency may be released. The releasing the determined operating frequency may include initializing the operating frequency of hardware devices or returning the operating frequency to a previous operating frequency at which the neural network model was executed.

In operation S19, the actual execution time of the neural network model may be feedbacked. An operating frequency determined based on the actual execution time of the neural network model may be adjusted. The adjusted operating frequency may be used when the same neural network model is triggered later.

According to an embodiment, the neural network computing system may optimize the operating frequency for each hardware device by performing feedback control based on the target execution time of the neural network model and the actual execution time of the neural network model. Since each hardware device may operate at an optimized operating frequency to process one or more neural network models, power consumption for the execution of the neural network model may be reduced while complying with the target execution time of the neural network model.

The execution time of a predetermined neural network model may vary due to various factors. In the case in which feedback control is performed for the operating frequency for each hardware device using only the immediately preceding execution time error, the operating frequency for each hardware device may also fluctuate greatly. Due to the large fluctuations in the operating frequency for each hardware device, it may be difficult for the actual execution time to converge to the target execution time. According to an embodiment, a smoothing technique may be applied to mitigate fluctuations in the operation frequency for each hardware device.

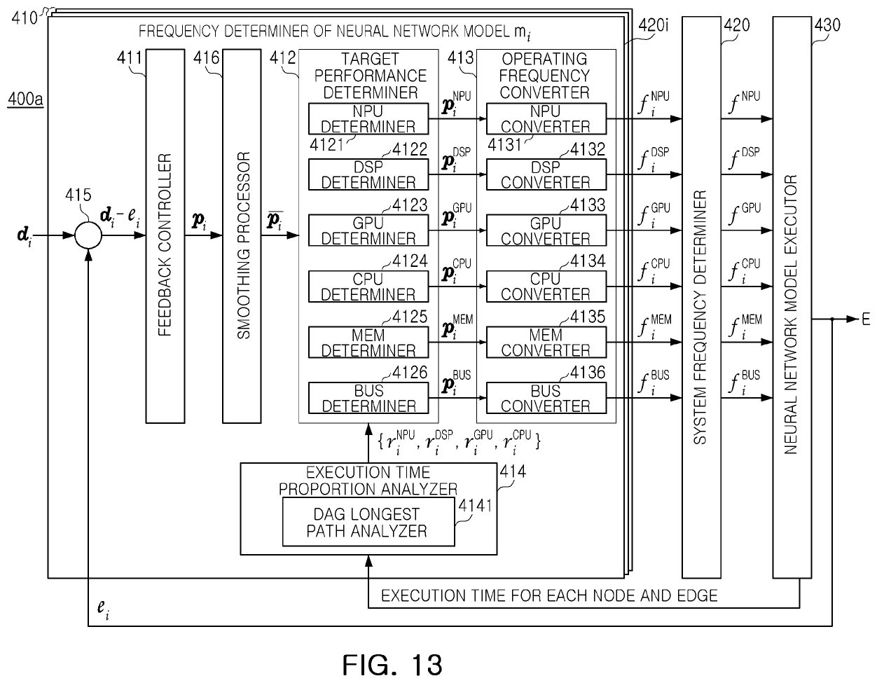

FIG. 13 is a diagram illustrating a neural network computing system according to an embodiment.

A neural network computing system 400a in FIG. 13 may include components similar to those of the neural network computing system 400 described with reference to FIG. 6. Hereinafter, the neural network computing system 400a in FIG. 13 will be described focusing on differences from the neural network computing system 400 in FIG. 6.

Differently from the plurality of frequency determiners 410 in FIG. 6, each of the plurality of frequency determiners 410 FIG. 13 may further include a smoothing processor 416. The smoothing processor 416 may output a smoothed target performance pᵢ by performing smoothing computation on the normalized target performance pᵢ of the neural network model m; output from the feedback controller 411. The smoothed target performance may be input to the target performance determiner 412.

The smoothing processor 416 may determine the smoothed target performance value based on an exponential smoothing technique for the normalized target performance values determined during execution of the previous neural network model. Specifically, a smoothed target performance value may be determined based on a weighted average value of normalized target performance values previously determined. Among the normalized target performance values, older values may be provided with a smaller weight, and more recent values may be provided with a larger weight. The weight may be determined based on a parameter having a value between “0” and “1.”

According to an embodiment, the plurality of frequency determiners 410 may control the actual execution time of the neural network model to converge to the target execution time by gently changing the operation frequency for each hardware device.

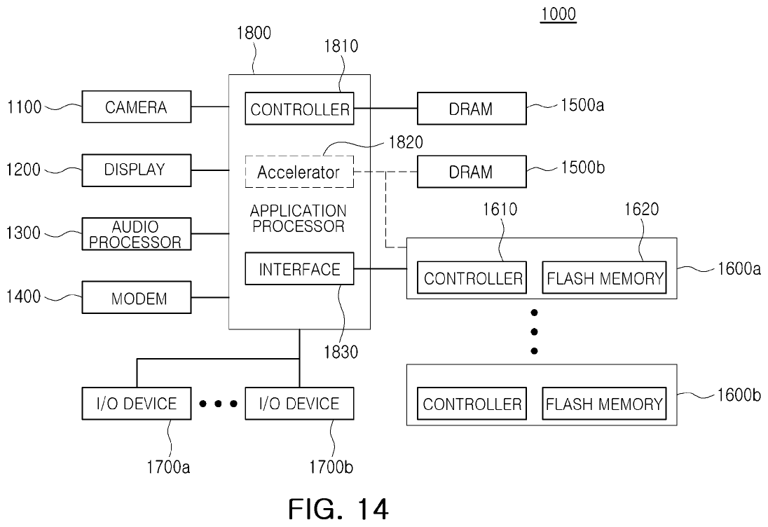

FIG. 14 is a diagram illustrating an electronic device to which a network computation system is applied according to an embodiment.

Referring to FIG. 14, a mobile system 1000 may include a camera 1100, a display 1200, an audio processor 1300, a modem 1400, DRAMs 1500a and 1500b, flash memory devices 1600a and 1600b, I/O devices 1700a and 1700b, and an application processor 1800 (hereinafter “AP”).

The mobile system 1000 may be implemented as a laptop computer, a portable terminal, a smartphone, a tablet PC, a wearable device, a healthcare device, or an Internet-of-Things (IoT) device. Also, the mobile system 1000 may be implemented as a server or a personal computer.

The camera 1100 may capture a still image or video under user control. The mobile system 1000 may obtain specific information using a still image/video captured by the camera 1100, or may convert the still image/video into other types of data such as text and may store the data. Alternatively, the mobile system 1000 may recognize a string included in a still image/video captured by the camera 1100 and may provide a text or audio translation corresponding to the string. As such, the application fields of the camera 1100 in the mobile system 1000 has been increasingly diverse. In an embodiment, the camera 1100 may transmit data such as a still image/video to the AP 1800 according to a D-Phy or C-Phy interface in accordance with the MIPI standard.

The display 1200 may be implemented in a liquid crystal display (LCD), an organic light emitting diode (OLED) display, an active-matrix organic light-emitting diode (AM-OLED), a plasma display panel (PDP), a field emission display (FED), and electronic paper. In an embodiment, the display 1200 may provide a touch screen function such that the display 1200 may be used as an input device of the mobile system 1000. Also, the display 1200 may be integrated with a fingerprint sensor and may provide a security function of the mobile system 1000. In an embodiment, the AP 1800 may transmit image data to be displayed on the display 1200 to the display 1200 according to a D-Phy or C-Phy interface in accordance with the MIPI standard.

The audio processor 1300 may process audio data stored in the flash memory devices 1600a and 1600b or audio data included in the content received from an external entity through the modem 1400 or the I/O device 1700a and 1700b. For example, the audio processor 1300 may perform various processes such as coding/decoding, amplification, and noise filtering on audio data.

The modem 1400 may modulate a signal for wired/wireless data transmission and reception and may transmit the modulated signal, and may demodulate a signal received from an external entity and may restore an original signal. The I/O devices 1700a and 1700b may provide digital input and output, and may include a port connected to an external recording medium, an input device such as a touch screen or a mechanical button key, and an output device output vibration in a haptic method. In an embodiment, the I/O devices 1700a and 1700b may be connected to external recording media through ports such as a USB, a lightning cable, an SD card, a microSD card, a DVD, a network adapter, and the like.

The AP 1800 may control overall operation of the mobile system 1000. Specifically, the AP 1800 may control the display 1200 to display a portion of content stored in the flash memory devices 1600a and 1600b on the screen. Also, when a user input is received through the I/O devices 1700a and 1700b, the AP 1800 may perform a control operation corresponding to the user input.

The AP 1800 may be provided as a system-on-chip (hereinafter referred to as “SoC”) for driving an application program, an operating system (OS), and the like. Also, the AP 1800 may be included in a single semiconductor package together with other devices included in the mobile system 1000, such as a DRAM 1500a, a flash memory 1620, and/or a memory controller 1610. For example, at least one device different from the AP 1800 may be provided in the form of a package such as package on package (POP), ball grid array (BGAs), chip scale package (CSPs), system in package (SIP), multichip package (MCP), wafer-level fabricated package (WFP), and wafer-level processed stack package. A kernel of an operating system executing on the AP 1800 may include an I/O scheduler and a device driver for controlling the flash memory devices 1600a and 1600b. The device driver may control access performance of the flash memory device 1600a and 1600b by referring to the number of synchronization queues managed by the I/O Scheduler, or may control the CPU mode and dynamic voltage and frequency scaling (DVFS) level in the SoC.

In an embodiment, the AP 1800 may include a processor block for executing computation or driving an application program and/or an operating system, and various other peripheral components connected to the processor block through a system bus. Peripheral components may include a memory controller, an internal memory, a power management block, an error detection block, a monitoring block, and the like. The processor block may include one or more cores, and when a plurality of cores are included in the processor block, each of the cores may include a cache memory, and a common cache shared by the cores may be included in the processor block.

In an embodiment, the AP 1800 may include an accelerator block 1820 which is a dedicated circuit for AI data computation. Alternatively, in an embodiment, another accelerator chip may be provided separately from the AP 1800, and a DRAM 1500b may be additionally connected to the accelerator block 1820 or the accelerator chip. The accelerator block 1820 may be a functional block specialized in performing specific functions of the AP 1800, and may include a graphics processing unit (GPU), which is a functional block specialized in processing graphics data, a neural processing unit (NPU), which is a block specialized in AI calculation and inference, and a data processing unit (DPU), a block specialized in data transmission.

According to an embodiment, the mobile system 1000 may include a plurality of DRAMs 1500a and 1500b. In an embodiment, the AP 1800 may include a controller 1810 for controlling DRAMs 1500a and 1500b, and the DRAM 1500a may be directly connected to the AP 1800.

The AP 1800 may determine a command and mode register set (MRS) conforming to the JEDEC standard and may control DRAM, or may communicate by setting specifications and functions required by the mobile system 1000, such as low voltage/high speed/reliability, and DRAM interface rules for CRC/ECC. For example, the AP 1800 may communicate with the DRAM 1500a through an interface conforming to JEDEC standards such as LPDDR4 and LPDDR5. Alternatively, the AP 1800 may set a new DRAM interface protocol and may perform communication to control the accelerator block 1820 or the accelerator chip provided separately from the AP 1800, the accelerator DRAM 1500b having a higher bandwidth than the DRAM 1500a.

Only the DRAMs 1500a and 1500b are illustrated in FIG. 14, but the configuration of the mobile system 1000 is not necessarily limited to the example, and a memory other than the DRAMs 1500a and 1500b may also be included in the mobile system 1000 depending on bandwidth, response speed, and voltage conditions of the AP 1800 or the accelerator block 1820. For example, the controller 1810 and/or the accelerator block 1820 may control various memories such as PRAM, SRAM, MRAM, RRAM, FRAM, and hybrid RAM. The DRAMs 1500a and 1500b may have a relatively smaller latency and higher bandwidth than those of the I/O devices 1700a and 1700b or the flash memory devices 1600a and 1600b. The DRAMs 1500a and 1500b may be initialized when the mobile system 1000 is powered on, and when the operating system and application data are loaded, the DRAMs 1500a and 1500b may be used as temporary storage positions for the operating system and application data or as execution spaces for various software codes.

In the DRAMs 1500a and 1500b, four rules of addition/subtraction/multiplication/division computing and vector computing, address computing, or FFT computing data may be stored. As another embodiment, the DRAMs 1500a and 1500b may be provided as a Processing In Memory (PIM) equipped with a computing function. For example, a function for execution used for inference may be performed within the DRAMs 1500a and 1500b. Here, inference may be performed in a deep learning algorithm using an artificial neural network. A deep learning algorithm may include a training operation for learning a model through various data and an inference operation for recognizing data with a learned model. For example, functions used for inference may include a hyperbolic tangent function, a sigmoid function, a Rectified Linear Unit (ReLU) function, and the like.

In an embodiment, an image captured by a user through the camera 1100 may be signal-processed and may be stored in the DRAM 1500b, and the accelerator block 1820 or accelerator chip may perform AI data computation of recognizing data using data stored in the DRAM 1500b and a function used for inference.

In an embodiment, the mobile system 1000 may include a plurality of storage or a plurality of flash memory devices 1600a and 1600b having a larger capacity than those of the DRAMs 1500a and 1500b. The flash memory devices 1600a and 1600b may include a controller 1610 and a flash memory 1620. The controller 1610 may receive a control command and data from the AP 1800, may write data to the flash memory 1620 in response to the control command, or may read data stored in the flash memory 1620 and may transmit the data to the AP 1800.

In an embodiment, the accelerator block 1820 or the accelerator chip may perform a training operation and AI data computation using flash memory devices 1600a and 1600b. In an embodiment, a block for executing a predetermined computation may be implemented inside the flash memory device 1600a and 1600b, and the block may execute at least a portion of an training operation and inference AI data computing performed by the AP 1800 and/or the accelerator block 1820 using data stored in the flash memory 1620 instead.

In an embodiment, the AP 1800 may include an interface 1830, and accordingly, the flash memory devices 1600a and 1600b may be directly connected to the AP 1800. For example, the AP 1800 may be implemented as an SoC, the flash memory device 1600a may be implemented as a separate chip different from the AP 1800, and the AP 1800 and the flash memory device 1600a may be implemented as different chips. However, the disclosure is not limited thereto, and a plurality of flash memory devices 1600a and 1600b may be electrically connected to the mobile system 1000 through connection.

The flash memory device 1600a and 1600b may store data such as a still image/video captured by the camera 1100, or may store data received through a communication network and/or a port included in the I/O devices 1700a and 1700b. For example, The flash memory device 1600a and 1600b may store augmented reality/virtual reality, high definition (HD), or ultrahigh definition (UHD) content.

In an embodiment, the AP 1800 may abstract the camera 1100 and may drive a camera application allowing a user to use the camera 1100. While the camera application is executed, the AP 1800 may drive a neural network model for detecting an object in an image frame generated by the camera application, and a neural network model for determining what the object is.

According to an embodiment, the AP 1800 may control an operating frequency for each hardware device based on a target execution time of each neural network model of each of various neural network models. Accordingly, the mobile system 1000 may reduce power consumption while complying with a target execution time of each neural network model.

According to the aforementioned an embodiment, the neural network computing system may determine an operating frequency of hardware devices by performing feedback control based on an error of the target execution time and the actual execution time of the neural network model, thereby reducing power consumption of hardware devices while complying with the target execution time of the neural network model.

Also, the neural network computing system may determine the operating frequency for each hardware device without causing excessive system overhead using a heuristic technique of using a proportion of execution time of each hardware device in the neural network model.

While various embodiments have been illustrated and described above, it will be configured as apparent to those skilled in the art that modifications and variations could be made without departing from the scope of the present disclosure as defined by the appended claims, and their equivalents.

What is claimed is:

1. A neural network computing system, comprising:
a processor comprising a plurality of computing devices;
a memory storing at least one instruction related to execution of a neural network model;
a memory controller configured to control data input/output of the memory; and
a system bus configured to support communication between the processor and the memory controller,
wherein the processor is configured to execute the at least one instruction to;
determine a normalized target performance of the neural network model by performing feedback control based on an error of a target execution time and an actual execution time of the neural network model,
determine a normalized target performance of each of the plurality of computing devices based on the normalized target performance of the neural network model and a proportion of execution time of each of the plurality of computing devices,
determine a normalized target performance of the memory controller and the system bus based on the normalized target performance of the neural network model,
determine an operating frequency for each of a plurality of hardware devices based on the normalized target performance of the plurality of computing devices, the memory controller and the system bus, the plurality of hardware devices comprising the plurality of computing devices, the memory controller, and the system bus, and
execute the neural network model by operating the plurality of hardware devices based on the determined operating frequency for each of the plurality of hardware devices.

2. The system of claim 1, wherein the processor is further configured to execute the at least one instruction to:
determine a highest performance value to be “1” based on each of the plurality of hardware devices operating at a highest operating frequency,
determine a lowest performance value to be “0” based on each of the plurality of hardware devices operating at a lowest operating frequency, and
determine the normalized target performance of the neural network model in a range of “0” to “1”.

3. The system of claim 1, wherein the processor is further configured to execute the at least one instruction to:
determine the normalized target performance for each computing device in inverse proportion to a proportion of execution time of each of the plurality of computing devices.

4. The system of claim 3, wherein the processor is further configured to execute the at least one instruction to:
determine normalized target performance of a computing device, from the plurality of computing devices, having a highest proportion of execution time as a same value as the normalized target performance of the neural network model.

5. The system of claim 1, wherein the processor is further configured to execute the at least one instruction to:
determine the normalized target performance for each computing device based on:
$${p}_{i}^{P U} = max ( 1 - ( 1 - {p}_{i} ) \cdot \frac{{r}_{i}^{Max}}{{r}_{i}^{P U}} , 0 )$$
where pᵢ^{PU} represents normalized target performance of an arbitrary computing device, p; represents normalized target performance of the neural network model, rᵢ^{PU} represents a proportion of execution time of the arbitrary computing device, and rᵢ^{Max} represents the highest value of a proportion of execution time of the plurality of computing devices.

6. The system of claim 1, wherein the processor is further configured to execute the at least one instruction to:
determine the normalized target performance of the memory controller and the system bus as the same value as normalized target performance of the neural network model.

7. The system of claim 1, wherein the normalized target performance of the memory controller and the system bus is determined as the same value as the normalized target performance of a computing device having a highest proportion of execution time among the plurality of computing devices.

8. The system of claim 1, wherein the processor is further configured to execute the at least one instruction to:
determine the operating frequency of the plurality of hardware devices in proportion to the normalized target performance for each of the plurality of hardware devices.

9. The system of claim 1, wherein the processor is further configured to execute the at least one instruction to:
determine the operating frequency of the plurality of hardware devices,
determine a reference frequency value proportional to the normalized target performance for each of the plurality of hardware devices within a range of the lowest operating frequency and a highest operating frequency selected for each hardware device, and
determine a lowest value not smaller than the reference frequency value among a plurality of discrete frequency values selected for each hardware device as the operating frequency for each hardware device.

10. The system of claim 1, wherein the processor is further configured to execute the at least one instruction to:
determine a proportion of execution time of each of the plurality of computing devices based on an execution time of each of the plurality of computing devices in the longest path among a plurality of paths of a directed acyclic graph included in the neural network model.

11. The system of claim 1, wherein the processor is further configured to execute the at least one instruction to:
feedback the actual execution time of the neural network model when execution of the neural network model is completed.

12. The system of claim 1, wherein the processor is further configured to execute the at least one instruction to:
determine smoothed target performance by performing smoothing on the normalized target performance of the neural network model and a plurality of normalized target performances previously determined for the neural network model, and
determine the normalized target performance for each computing device and the normalized target performance of the memory controller and the system bus using the smoothed target performance as the normalized target performance of the neural network model.

13. The system of claim 1, wherein the plurality of computing devices include a central processing unit (CPU), a neural processing unit (NPU), a graphic processing unit (GPU), and a digital signal processor (DSP).

14. The system of claim 1, wherein the processor is further configured to execute the at least one instruction to:
receive the target execution time of the neural network model through an application programming interface (API).

15. A neural network computing system, comprising:
a processor comprising a plurality of computing devices;
a memory storing at least one instruction related to execution of a plurality of neural network models;
a memory controller configured to control data input/output of the memory; and
a system bus configured to support communication between the processor and the memory controller,
wherein the processor is configured to execute the at least one instruction to execute;
a plurality of frequency determiners corresponding to a plurality of neural networks, each frequency determiner configured to determine a plurality of operating frequencies for each of a plurality of hardware devices by performing feedback control based on an error of a target execution time and an actual execution time of the corresponding neural network model, and an execution time of each node and each edge of the corresponding neural network model, the plurality of hardware devices comprising the plurality of computing devices, the memory controller and the system bus,
a system frequency determiner configured to determine a highest value from the plurality of operating frequencies for each hardware device as a system operating frequency for each of the plurality of hardware devices, and
a neural network model executor configured to execute the plurality of neural network models by controlling the plurality of hardware devices according to the system operating frequency determined for each of the plurality of hardware devices, and output the actual execution time of the plurality of neural network models and the execution time of each node and each edge of the plurality of neural network models.

16. The system of claim 15, wherein each of the plurality of frequency determiners is further configured to:
determine a longest path based on a connection relationship between a plurality of nodes and a plurality of edges of the corresponding neural network model,
determine a proportion of execution time of the plurality of computing devices based on an actual execution time of the plurality of nodes and the plurality of edges in the longest path, and
determine an operating frequency of the plurality of computing devices based on an error of the actual execution time and the proportion of execution time.

17. The system of claim 15, further comprising:
a camera,
wherein the processor is further configured to execute the at least one instruction to;
execute a camera application configured to generate an image frame using the camera, and
wherein the plurality of neural network models comprise at least one model for detecting an object in the image frame, at least one model for identifying what an object is, at least one model for detecting a target area in the image frame, at least one model for identifying the detected target area, and at least one model for classifying the identified target areas according to meaning.

18. A method of executing a neural network model, comprising:
triggering frequency scaling of a neural network model in response to a trigger of the neural network model;
determining a target performance of the neural network model based on an error between a target execution time of the neural network model and a previous actual execution time of the neural network model;
determining, with respect to a plurality of heterogeneous computing devices configured to execute the neural network model, a target performance for each heterogeneous computing device based on the target performance of the neural network model and an execution time of each node and each edge of the neural network model;
determining an operating frequency for each heterogeneous computing device to execute the neural network model based on the target performance for each heterogeneous computing device;
setting a system operating frequency for each heterogeneous computing device based on a plurality of operating frequencies determined for each heterogeneous computing device for executing a plurality of neural network model being executed including the neural network model; and
executing the neural network model according to the system operating frequency for each heterogeneous computing device.

19. The method of claim 18, further comprising:
releasing the system operating frequency determined for each heterogeneous computing device based on execution of the neural network model being completed.

20. The method of claim 18, further comprising:
feeding back the previous actual execution time of the neural network model and the execution time of each node and each edge of the neural network model.
